(19) United States
(12) Patent Application Publication
(10) Pub. No.: US 2010/0287817 A1
(43) Pub. Date: Nov. 18, 2010

(54) Method for Ant Control

(75) Inventors: Thomas E. Anderson, Yardley, PA (US); William T. Sommer, Mendham, NJ (US); James F. Walter, West Chester, PA (US); Mark Wusaty, Scotch Plains, NJ (US)

Correspondence Address: PATENT ADMINISTRATOR;FMC CORPORATION, 1735 MARKET STREET, PHILADELPHIA, PA, 19103, US

(73) Assignee: FMC Corporation, Philadelphia, PA (US)

(21) Appl. No.: 12/764,151

(22) Filed: Apr. 21, 2010

Related U.S. Application Data
(60) Provisional application No. 61/178,312, filed on May 14, 2009.

(51) Int. Cl. A01M 1/20; A01M 99/00

(52) U.S. Cl. 43/132.1

(57) ABSTRACT

The present invention relates to a method for controlling carpenter ants comprising applying an insecticidally effective amount of a composition comprising:
1) a solid granular support and
2) a mixture of zeta-cypermethrin and bifenthrin
   to a locus where ant control is needed or expected to be needed. The insecticidal solid granular compositions exhibit quick knockdown of carpenter ants and harvester ants.

### FIELD OF THE INVENTION

The present invention relates to a method of controlling ants using insecticidal solid granular compositions containing zeta-cypermethrin and bifenthrin.

### BACKGROUND OF THE INVENTION

Ants, such as carpenter ants and harvester ants, are insects that have the potential to cause nuisance or harm to person and property.

Carpenter ants such as the black carpenter ant (Camponotus pennsylvanicus), the red carpenter ant (Camponotus ferrugineus) and the smaller carpenter ant (Camponotus nearcticus) are insect pests that cause major damage to buildings because they house their colonies in galleries they excavate in moist wood and sometimes, foam insulation. Carpenter ants do not always need a moist area to nest as they also use an old abandoned nest or wood hollowed out by termites. Carpenter ants do not eat the wood they remove during their nest building activities, but deposit it outside entrances to the colony in piles which include, in addition to the wood fragments, other debris from the nest, including bits of soil, empty seed coats, dead ants and parts of insects and remnants of other food scraps, creating an unhealthy environment for humans and domestic animals.

Harvester ants such as the California red harvester ant (Pogonomyrmex californicus) clear areas of grass around their nest and along forage trails radiating from the central nest, using the grass to construct nest mounds. Generally, nests are constructed in open areas and are a real problem on golf courses, recreational areas and occasionally in lawns. They also hinder reseeding of areas as they collect the seed as a source of food. In addition, they can sting both humans and animals, causing great pain.

It would be advantageous to provide an easy to use, inexpensive compositions and methods of using these compositions for controlling these pests that provide the benefits of faster knockdown and residual activity for long term control.

### SUMMARY OF THE INVENTION

In accordance with the present invention, it has now been found that a solid granular composition comprising 1) a solid granular support and 2) a mixture of zeta-cypermethrin and bifenthrin that is applied to the solid support provides improved control of ants. Specifically, the insecticidal solid granular compositions exhibit quick knockdown of carpenter ants and harvester ants. Other aspects of the present invention will also be apparent.

### DETAILED DESCRIPTION OF THE INVENTION

The present invention relates to a method for controlling ants comprising applying an insecticidally effective amount of a composition comprising:

1) a solid granular support and

2) a mixture of zeta-cypermethrin and bifenthrin

to a locus where ant control is needed or expected to be needed. The insecticidal solid granular compositions exhibit unexpected quick knockdown of ants when compared to the individual active components.

The insecticidal solid granular compositions used in the present invention are prepared by dissolving zeta-cypermethrin and bifenthrin in a solute, either individually or in combination, and applying the so formed solution, or solutions, evenly to a suitable solid granule carrier.

The solute is a solvent in which both zeta-cypermethrin and bifenthrin are completely soluble in or a mixture of solvents that dissolve both zeta-cypermethrin and bifenthrin completely. The preferred solute is a mixture of solvents consisting of a synthetic isoparaffinic hydrocarbon, for example, Isopar™ M available from ExxonMobil Chemical Company, and a diisopropylbiphenyl, for example, NuSolv ABP 103 available from BVA Oils Inc.

Preferably the granular solid support is a non-reactive, porous support that will release the insecticide mixture to the target site. Examples of preferred granular solid supports are dolomitic limestone and wood dust based chemical carriers, for example, DG Lite™ available from The Andersons, Inc.; a cellulose complex, for example, Biodac® available from Kadant GranTek, Inc.; wood fiber granules, for example, EcoGranule™ available from Cycle Group, Inc.; crushed corn cob, for example, Bed-o'cobs® available from The Andersons, Inc. or Maizorb® available from Mt. Pulaski Products, Inc.; crushed peanut shells; sand, and granular nitrogen/phosphorus/potassium (NPK) fertilizers.

Preferably, the insecticidal solid granule composition comprises a mixture of zeta-cypermethrin active ingredient and bifenthrin active ingredient present in the weight ratio from 1:20 to a ratio of 10:1, zeta-cypermethrin to bifenthrin; most preferable a ratio of 1:4. Preferably, the amount of combined insecticide active ingredients present in the composition is from 0.01% by weight to 5.0% by weight of the total weight of the composition, more preferably from 0.1% to 0.3% by weight of the total weight of the composition.

A preferred embodiment of the present invention is a method for controlling ants comprising applying an insecticidally effective amount of a composition comprised of 1) a solid granular support and 2) a mixture of zeta-cypermethrin and bifenthrin that has been applied to the solid support to a locus where ant control is needed or expected to be needed. For carpenter ant control, the application of the insecticidal composition disclosed in the present invention can be accomplished by introducing the dry granular composition into the carpenter ant nest through entrance holes using a hand duster with a tube and a tip that fits snugly in the entrance. Alternatively, an application can be made by drilling holes into the wall, sills or joists to intercept cavities and galleries of the carpenter ant nest and applying the dry granular composition into these holes. Applying the dry granular composition to baseboards, cracks and crevices around the infested area will control foraging carpenter ants that leave or return to the nest. Although the method of the present invention employs the quick acting composition comprising zeta-cypermethrin and bifenthrin, carpenter ants returning to the nest have enough time to carry the insecticidal composition on their feet into the nest before dying.

For harvester ant control, the application of the insecticidal composition disclosed in the present invention can be accomplished by introducing the dry granular composition into and around the harvester ant nest through entrance holes.

The term “zeta-cypermethrin” means (R,S)-α-cyano-3-phenoxybenzyl-(1RS)-cis-trans-3-(2,2-dichlorovinyl)-2,2-dimethylcyclopropanecarboxylate which has been enriched in the 1R-cis-S and 1R-trans-S isomers.

The term “bifenthrin” means 2-methylbiphenyl-3-ylmethyl (Z)-(1RS)-cis-3-(2-chloro-3,3,3-trifluoroprop-1-enyl)-2,2-dimethyl cyclopropanecarboxylate.

The following examples further illustrate the present invention, but, of course, should not be construed as in any way limiting its scope. The examples set forth certain data demonstrating the improved efficacy of the compositions of the present invention.

### Example 1

### Preparation of a Solid Granule Composition Containing 0.144% Zeta-Cypermethrin and Bifenthrin on Crushed Peanut Hulls

Into a mixing vessel, affixed with an overhead mechanical stirrer, was added 1.87 pounds of melted zeta-cypermethrin (38.5% active ingredient, prepared by the process disclosed in U.S. Pat. No. 4,997,970), 2.99 pounds of melted bifenthrin (96.2% active ingredient), 1.3 pounds of Isopar™ M and 15.94 pounds of NuSolv ABP 103. The mixture was stirred for 30 minutes. The resultant insecticide solution contained a 1:4 wt/wt mixture of zeta-cypermethrin to bifenthrin.

Crushed peanut hulls (3.96 pounds) were added to a tumble blender. A portion of the insecticide solution prepared above (0.035 pound, warmed to 50° C.) was placed into a hand held sprayer. While the crushed peanut hulls tumbled in the blender, the warm insecticide solution was sprayed onto the hulls using a fine mist.

Mixing was continued for 15 minutes after all the insecticide solution was applied. The resultant insecticidal solid granular composition contained 0.144% of the insecticidal active ingredients in a ratio of 1:4, zeta-cypermethrin to bifenthrin. This insecticidal solid granular composition was packaged into containers for storage.

### Example 2

### Preparation of a Solid Granule Composition Containing 0.25% Zeta-Cypermethrin and Bifenthrin on Crushed Peanut Hulls

In a manner similar to Example 1, 0.06 pound of the insecticide solution was sprayed onto 3.92 pounds of peanut hulls. The resultant insecticidal solid granular composition contained 0.25% of the insecticidal active ingredients in a ratio of 1:4, zeta-cypermethrin to bifenthrin. This insecticidal solid granular composition was packaged into containers for storage.

### Comparative Example

### Preparation of a Solid Granule Composition Containing 0.086% Zeta-Cypermethrin on Crushed Peanut Hulls

Into a mixing vessel, affixed with an overhead mechanical stirrer, was added 2.16 pounds of melted zeta-cypermethrin (38.5% active ingredient, prepared by the process disclosed in U.S. Pat. No. 4,997,970), 0.34 pound of Isopar™ M and 6.25 pounds of NuSolv ABP 103. The mixture was stirred for 30 minutes to yield a zeta-cypermethrin insecticide solution containing 9.5% (wt %) zeta-cypermethrin.

Crushed peanut hulls (6.64 pounds) were added to a tumble blender. A portion of the zeta-cypermethrin insecticide solution prepared above (0.06 pound, warmed to 50° C.) was placed into a hand held sprayer. While the crushed peanut hulls tumbled in the blender, the warm zeta-cypermethrin insecticide solution was sprayed onto the hulls using a fine mist. Mixing was continued for 15 minutes after all the zeta-cypermethrin insecticide solution was applied. The resultant insecticidal solid granular composition contained 0.086% of the insecticidal active ingredient.

This zeta-cypermethrin insecticidal solid granular composition was packaged into containers for storage.

### Example 3

Insecticidal Evaluation of Insecticidal Solid Granule Compositions Against Carpenter Ants (Camponotus pennsylvanicus)

The compositions of the present invention were tested for insecticidal activity against adult carpenter ants in the following manner:

The edges of a 100 mm disposable Petri dish were coated with polytetrafluoroethylene (Fluon AD1, available from Northern Product, Woonsocket R.I.) in order to prevent the ants from escaping. Enough of the solid granule test composition was used in order to completely cover the bottom of the Petri dish. Either five or ten adult carpenter ants were placed in each Petri dish directly onto the solid granule test composition. The total number of ants used in each test are indicated in Table 1 below. The ants were examined at five minute increments up to 70 minutes. The percent knockdown was assessed by counting the number of insects that were moribund and dead. An insect was considered moribund if it responded to probing but could not right itself within 10 seconds of being turned upside down. An insect was considered dead if it did not respond to probing. Table 1 below summarizes the percent knockdown of the test compositions. The bold numbers indicate that a beneficial insecticidal effect was observed when compared to the individual compounds.

TABLE 1
Percent Knockdown of Insecticidal Solid Granular Compositions

| Treatment* | % Knockdown at | | | | | | | |
|---|---|---|---|---|---|---|---|---|
| Total # ants | Rate Lb | 1 | 5 | 10 | 15 | 20 | 25 | 30 |
| in test | AI/1000 ft² | minute | minutes | minutes | minutes | minutes | minutes | minutes |
| Example 1 | 4.0 | 0 | 0 | 0 | 0 | 8 | 36 | 68 |
| 25 ants | | | | | | | | |
| Comparative | 1.34 | 0 | 3 | 0 | 0 | 3 | 18 | 43 |
| Example | | | | | | | | |
| 40 ants | | | | | | | | |
| Bug-B-Gone | 4.0 | 4 | 4 | 4 | 4 | 4 | 16 | 16 |
| 25 ants | | | | | | | | |
| Untreated | — | 0 | 0 | 0 | 0 | 0 | 0 | 0 |
| Control | | | | | | | | |
| 20 ants | | | | | | | | |
| Treatment* | Rate Lb | 40 | 45 | 50 | 55 | 60 | 65 | 70 |
| # ants in test | AI/1000 ft² | minute | minutes | minutes | minutes | minutes | minutes | minutes |
| Example 1 | 4.0 | 92 | 93 | 100 | 100 | 100 | 100 | 100 |
| 25 ants | | | | | | | | |
| Comparative | 1.34 | 78 | 90 | 98 | 100 | 100 | 100 | 100 |
| Example | | | | | | | | |
| 40 ants | | | | | | | | |
| Bug-B-Gone | 4.0 | 16 | 24 | 36 | 52 | 68 | 88 | 100 |
| 25 ants | | | | | | | | |
| Untreated | — | 0 | 0 | 0 | 0 | 0 | 0 | 0 |
| Control | | | | | | | | |
| 20 ants | | | | | | | | |

*Example 1 = 0.144% Granule Composition of zeta-Cypermethrin and Bifenthrin combined AI on Crushed Peanut Hulls
Comparative Example = 0.086% Granule Composition of zeta-Cypermethrin AI on Crushed Peanut Hulls
Bug-B-Gone ® Max Granules available from Ortho Products contains 0.2% Bifenthrin AI.

### Example 4

Insecticidal Evaluation of Solid Granule Compositions Against Harvester Ants (Pogonomyrmex californicus)

Compositions of the present invention were prepared in a manner similar to Examples 1 and 2, using DG Lite™ or sand as the solid support, in a number of different ratios. These compositions, summarized in Table 2 below, were tested for insecticidal activity against adult harvester ants as follows:

The edges of a 100 mm disposable Petri dish were coated with polytetrafluoroethylene (Fluon AD1, available from Northern Product, Woonsocket R.I.) in order to prevent the ants from escaping. A circular filter paper was placed on the bottom of the Petri dish and moistened with 1 mL of deionized water. Enough of the solid granule test composition was used in order to completely cover the bottom of the Petri dish. There were four replicates per test using from eight to ten adult harvester ants per replicate. The harvester ants were placed onto the solid granule test composition and were examined at five minute increments for up to 50 or 60 minutes. The percent knockdown was assessed by counting the number of insects that were moribund and dead. An insect was considered moribund if it responded to probing but could not right itself within 10 seconds of being turned upside down. An insect was considered dead if it did not respond to probing. Table 2A below summarizes the percent knockdown of the test compositions. The bold numbers indicate that a beneficial insecticidal effect was observed when compared to bifenthrin alone.

TABLE 2
Compositions of the Present Invention on DG Lite ™ or
Sand as the Solid Support

| | | Ratio of zeta- | % Total Active |
|---|---|---|---|
| Example | Support | Cypermethrin to | Ingredients on |
| Number | Medium | Bifenthrin | Solid Support |
| 4A | DG Lite ™ | 1:4 | 0.05 |
| 4B | DG Lite ™ | 1:20 | 0.21 |
| 4C | DG Lite ™ | 10:1 | 0.22 |
| 4D | DG Lite ™ | 1:4 | 5.0 |
| 4E | DG Lite ™ | 1:4 | 0.25 |
| 4F | Sand | 1:4 | 0.25 |

TABLE 2A
Percent Knockdown of Insecticidal Solid Granular Compositions

| | | % Knockdown at | | | | | |
|---|---|---|---|---|---|---|---|
| | Rate Lb | 5 | 10 | 15 | 20 | 25 | 30 |
| Treatment | AI/1000 ft² | minutes | minutes | minutes | minutes | minutes | minutes |
| *Standard | 4.0 | 3 | 3 | 3 | 5 | 20 | 48 |
| for 4A-D | | | | | | | |
| 4A | 20.0 | 0 | 0 | 23 | 70 | 100 | 100 |
| 4B | 4.0 | 0 | 0 | 0 | 10 | 28 | 50 |
| 4C | 4.0 | 0 | 8 | 63 | 83 | 100 | 100 |
| 4D | 0.2 | 3 | 3 | 20 | 48 | 65 | 83 |
| *Standard | 4.56 | 0 | 0 | 0 | 0 | 0 | 0 |
| for 4E-F | | | | | | | |
| 4E | 4.56 | 0 | 0 | 11 | 17 | 44 | 81 |
| 4F | 4.56 | 0 | 0 | 19 | 46 | 57 | 70 |
| Untreated | — | 0 | 0 | 0 | 0 | 0 | 0 |
| Control | | | | | | | |
| Sand | | | | | | | |
| | Rate Lb | 35 | 40 | 45 | 50 | 55 | 60 |
| Treatment | AI/1000 ft² | minute | minutes | minutes | minutes | minutes | minutes |
| *Standard for | 4.0 | 68 | 85 | 95 | 100 | ND | ND |
| 4A-D | | | | | | | |
| 4A | 20.0 | 100 | 100 | 100 | 100 | ND | ND |
| 4B | 4.0 | 85 | 100 | 100 | 100 | ND | ND |
| 4C | 4.0 | 100 | 100 | 100 | 100 | ND | ND |
| 4D | 0.2 | 95 | 100 | 100 | 100 | ND | ND |
| *Standard | 4.56 | 11 | 14 | 30 | 24 | 54 | 60 |
| for 4E-F | | | | | | | |
| 4E | 4.56 | 75 | 81 | 61 | 69 | 75 | 75 |
| 4F | 4.56 | 73 | 70 | 65 | 89 | 65 | 92 |
| Untreated | — | 0 | 0 | 0 | 0 | 0 | 0 |
| Control | | | | | | | |
| Sand | | | | | | | |

*Standard contains 0.2% Bifenthrin AI on DG Lite ™ solid support.
ND = No Data

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method for controlling ants comprising applying an insecticidally effective amount of a composition comprising:
1) a solid granular support and
2) a mixture of zeta-cypermethrin and bifenthrin
to a locus where ant control is needed or expected to be needed.

2. The method of claim 1, wherein said solid granular support is dolomitic limestone and wood dust, crushed peanut shells or sand.

3. The method of claim 1, wherein said mixture of zeta-cypermethrin and bifenthrin active ingredients are present in the ratio from 1:20 to a ratio of 10:1.

4. The method of claim 3, wherein said mixture of zeta-cypermethrin and bifenthrin are present in the ratio of 1:4.

5. The method according to claim 4, wherein said ant is selected from carpenter ant and harvester ant.

6. The method according to claim 4, wherein said locus is a golf course, athletic field, park, lawn, an ant infested structure, a structure that is expected to be ant infested, or a location adjacent to the structure.
